(19) United States
(12) Patent Application Publication
(10) Pub. No.: US 2026/0249326 A1
(43) Pub. Date: Aug. 27, 2026

(54) MOBILE MATERIAL SORTING APPARATUS

(71) Applicant: KIVERCO LIMITED, Dungannon, Tyrone (GB)

(72) Inventor: Aidan MCKIVER, Dungannon, Tyrone (GB)

(21) Appl. No.: 18/290,940

(22) PCT Filed: Jul. 20, 2022
(86) PCT No.: PCT/EP2022/070432

§ 371 Date: Jan. 22, 2024

(30) Foreign Application Priority Data
Jul. 20, 2021 (GB) 2110436.9

(51) Int. Cl. B07C 5/36; B07B 1/00; B07B 13/14; B07C 5/342

(52) U.S. Cl. CPC B07C 5/362; B07B 1/005; B07B 13/14; B07C 5/342; B07C 5/363; B07C 2501/0054

(57) ABSTRACT

A mobile material sorting apparatus 1 comprises: a material intake means 2; a material separation means 3-5; at least one sorted material transfer means 7 comprising a conveyor means at least partially locatable below the material separation means 3-5; and a transportation means 8 comprising one or more endless tracks. The material separation means 3-5 comprises a sorting station 4 directly or indirectly connected to the transportation means 8 having an optical sorting arrangement.

The present invention relates to a mobile material sorting apparatus, particularly to a mobile sorting station for sorting materials in a material stream.

Many countries around the world are rapidly running out of landfill space. As such, it is becoming increasingly important to reduce our reliance on landfill sites. Finding ways to divert waste from landfills is beneficial as it removes the emissions caused by transporting the material to landfill as well as the costs associated with burying waste. While some countries have resorted to large-scale incineration of waste material, recycling is far preferable from an environmental standpoint. Waste streams typically include multiple categories of material such as fines, soil, plastics, aggregates and metal, many of which can be effectively used in new products. However, before recycling can take place these different categories of material must be separated and sorted. This can prove difficult and time-consuming.

When sorting large-volume waste streams it is common to use immobile purpose-built material sorting installations. Such installations of the known type comprise a plurality of stand-alone sorting stations connected via conveyors. Because these systems have a large footprint and because they are complicated and time-consuming to set up, they are often permanently installed within waste facility buildings. Such systems are difficult or impossible to move around a site and are difficult to adapt when for example the layout of storage bays/skips must be changed. Where the system is to be moved only a short distance, of the order of a few meters or so, large parts of the system would need to be completely dismantled and re-built. Such time-consuming reconfigurations can prove wasteful and inefficient, having a negative impact on the environment.

It is an object of the invention to obviate or mitigate the problems outlined above.

In particular, it is an object of the invention to reduce carbon emissions associated with the transport and setup of material sorting equipment.

It is a further object of the invention to provide a material sorting apparatus which can be easily transported and maneuvered on a site.

It is a further object of the invention to provide a material sorting apparatus which can be easily installed in multiple on-site locations.

It is a further object of the invention to provide a material sorting apparatus which can be used to sort various types of material in a material stream.

It is a further object of the invention to provide a material sorting apparatus which can be used to sort material in an industrial or domestic material stream.

It is a further object of the invention to provide a material sorting apparatus which can be used in an automated material sorting process.

According to a first aspect of the invention there is provided a mobile material sorting apparatus comprising: a material intake means; a material separation means; at least one sorted material transfer means comprising a conveyor means at least partially locatable below the material separation means; and a transportation means comprising one or more endless tracks, wherein the material separation means comprises a sorting station directly or indirectly connected to the transportation means. Advantageously, the transportation means allows the mobile material sorting apparatus to be moved and/or to maneuver itself to an appropriate position on a site.

According to a second aspect of the invention there is provided a mobile material sorting apparatus comprising: a material intake means; a material separation means; at least one sorted material transfer means; and a transportation means, wherein the material separation means is directly or indirectly connected to the transportation means. Advantageously, the sorted material transfer means allows material separated from a material stream to be transferred from the mobile material sorting apparatus to e.g. a storage means such as a stockpile, bay, silo, skip or cage. According to a third aspect of the invention there is provided a mobile material sorting apparatus comprising: a material intake means; a material separation means; at least one sorted material transfer means; and a transportation means, wherein the material separation means comprises an optical sorting means directly or indirectly connected to the transportation means. Advantageously, the mobile material sorting apparatus can be used to optically sort materials in a variety of locations and can be easily transported to and/or maneuvered on a site.

Ideally the mobile material sorting apparatus is for sorting materials in a material stream.

Optionally the mobile material sorting apparatus is a waste sorting apparatus.

Optionally the mobile material sorting apparatus is an apparatus for separating materials in a waste stream.

Optionally the mobile material sorting apparatus is an apparatus for optically sorting materials in a material stream.

Preferably the transportation means is configured to allow the mobile material sorting apparatus to move around a site. Advantageously, the transportation means provides a means by which the mobile material sorting apparatus can be re-oriented with respect to one or more storage means.

Preferably the transportation means comprises one or more tracks.

Preferably the transportation means comprises one or more endless tracks.

Preferably the transportation means comprises one or more track assemblies.

Preferably the transportation means comprises two track assemblies.

Preferably the or each track assembly comprises a plurality of wheels and an endless track disposed around the wheels. Advantageously, the endless track engages the ground to provide traction and is moved by the wheels to provide motion.

Preferably the or each track assembly is adapted to propel the mobile material sorting apparatus, in use.

Preferably the mobile material sorting apparatus comprises a support chassis, such as an elongate support chassis.

Preferably the transportation means is attachable to the support chassis.

Preferably the or each track assembly is attachable to the elongate support chassis.

Preferably one or more components of the mobile material sorting apparatus is mounted on the support chassis.

Preferably the transportation means is attached to an elongate chassis on which the material separation means is/are mounted.

Optionally the transportation means comprises one or more wheels.

Ideally the mobile material sorting apparatus comprises a material intake means.

Preferably the material intake means comprises a material entrance.

Preferably the material intake means comprises a material entrance for receiving material.

Preferably the material intake means comprises a material entrance for receiving waste material from a building or domestic site, or any other material to be sorted.

Preferably the material intake means comprises a material exit.

Preferably the material intake means comprises a material exit configured to allow material placed into the material intake means to move out of the material intake means.

Preferably the material intake means comprises a material exit configured to allow material placed into the material intake means to move towards at least one material separation means.

Preferably the material intake means comprises a material exit configured to allow material placed into the material intake means to move towards the material separation means.

Preferably the material intake means comprises a feed conveyor.

Preferably the material intake means comprises a feed conveyor which is horizontal or inclined, in use.

Optionally the material intake means comprises an inclined feed conveyor.

Optionally the material intake means comprises a horizontal feed conveyor.

Preferably the feed conveyor is adapted to transport material in the material intake means towards the material exit of the material intake means.

Preferably the mobile material sorting apparatus comprises one or more material separation means.

Optionally the mobile material sorting apparatus comprises a plurality of material separation means.

Preferably each material separation means is adapted for allowing at least one predetermined category of materials to be separated from the material stream.

Preferably the material separation means comprises an air separation means.

Preferably the air separation means is adapted to separate low density/lighter material from other materials in the material stream.

Preferably the air separation means is adapted to generate a flow of air.

Preferably the air separation means is adapted to generate a flow of air towards material in the material stream.

Preferably the air separation means is adapted to generate a flow of air towards material in the material stream as it passes into and/or through the material intake means.

Preferably the air separation means is adapted to generate a flow of air towards material in the material stream as it travels along the feed conveyor towards the material exit of the material intake means.

Optionally the air separation means is adapted to generate a flow of air towards a chute.

Preferably a storage means such as a lights skip is located at the end of the chute. Advantageously, lights separated from the waste stream by the air separation means can fall into and be collected in the skip.

Optionally a conveyor means is located at the end of the chute.

Optionally the air separation means is adapted to generate a flow of air towards a storage means such as a stockpile, skip, cage, bay or silo.

Preferably the air separation means comprises an air-flow generation means.

Preferably the air flow generation means comprises a fan or blower.

Preferably the air separation means comprises an outlet.

Preferably the air flow generation means of the air separation means is connected to the outlet via one or more ducts.

Preferably the air separation means is mechanically coupled to the material intake means.

Preferably material in the material stream passes an air separator as it passes along the feed conveyor.

Preferably the feed conveyor is adapted to transport material out of the material intake means.

Preferably the feed conveyor is adapted to transport unseparated material out of the intake means.

Preferably the feed conveyor is adapted to transport material that has not been separated from the material stream by the air separator.

Preferably the feed conveyor is located generally below the outlet of the air separator means.

Preferably the material intake means comprises one or more material entrances for receiving material.

Optionally the material intake means comprises a cover member.

Optionally the material intake means comprises front and rear apertures.

Optionally the front and rear apertures are located on opposing sides of the intake cover member.

Preferably the material intake means is mechanically coupled to the support chassis.

Ideally the mobile material sorting apparatus comprises a plurality of material separation means.

Preferably each material separation means is adapted for allowing at least one predetermined category of materials to be separated from the material stream.

Ideally the mobile material sorting apparatus comprises a sorting station.

Preferably the sorting station comprises a manual separation means i.e. a means adapted to allow the manual separation of items from the material stream.

Preferably the sorting station comprises a manual picking station and/or another separation means.

Optionally the sorting station comprises a robotic sorting means, an optical sorting means, a near-infrared sorting means and/or air separation means.

Preferably the sorting station comprises a housing.

Preferably the housing comprises a roof.

Preferably the housing comprises a floor.

Preferably the housing comprises one or more side walls and/or end walls.

Preferably the housing comprises two side walls which extend between the floor and the roof.

Preferably the housing comprises two end walls which extend between the floor and the roof.

Preferably the housing comprises one or more personnel access means.

Preferably the personnel access means comprise one or more doors or openings.

Preferably one or more personnel access means are located in the side walls and/or end walls of the housing.

Preferably the personnel access means are accessible from the ground via a ladder or a set of stairs or other suitable means.

Preferably the sorting station is a multi-bay sorting station.

Preferably the sorting station comprises one or more picking positions.

Preferably the sorting station comprises at least two picking positions.

Preferably the or each picking position is located inside the sorting station.

Preferably the sorting station comprises a material entrance.

Preferably a material stream is able to enter the sorting station via the material entrance.

Preferably the material entrance is located in an end wall of the housing.

Preferably the sorting station comprises a material exit.

Preferably the material stream can exit the sorting station via the material exit.

Preferably unpicked/unsorted material in the material stream can exit the sorting station via the material exit. Preferably the material exit is an exit for unsorted and/or sorted material. Advantageously, material can be positively and negatively sorted which can leave sorted material on the conveyor which exits the sorting station: e.g. picking contaminants from hardcore so that

Preferably the material exit is located in an end wall of the housing.

Ideally the mobile material sorting apparatus comprises an unsorted and/or sorted material transfer means.

Preferably the unsorted and/or sorted material transfer means comprises a conveyor means.

Preferably the unsorted and/or sorted material transfer means is a conveyor.

Preferably the unsorted and/or sorted material transfer means is a picking conveyor.

Preferably the conveyor or picking conveyor comprises a frame.

Preferably the conveyor or picking conveyor comprises a frame which is attached to the housing and/or the support chassis.

Preferably the conveyor or picking conveyor comprises a frame located within the housing of the sorting station.

Preferably the conveyor or picking conveyor comprises a frame which passes through the housing of the sorting station.

Preferably the conveyor or picking conveyor comprises an endless belt which rotates to carry material thereon.

Preferably the conveyor or picking conveyor comprises a plurality of consecutive conveyor belts.

Preferably the unsorted material transfer means is adaptable to carry material in either direction through the mobile material sorting apparatus.

Preferably the unsorted material transfer means passes through the sorting station.

Preferably the unsorted material transfer means comprises an input portion.

Preferably material which exits the material intake means falls onto the input portion of the unsorted material transfer means where it is carried towards the sorting station.

Optionally the unsorted material transfer means comprises a horizontal input portion.

Optionally the unsorted material transfer means comprises an inclined input portion.

Preferably material which exits the material input means falls onto the input portion where it is carried towards the sorting station.

Preferably the unsorted material transfer means comprises a central portion.

Preferably material is carried through the sorting station on the central portion.

Preferably the unsorted material transfer means comprises a terminal portion.

Preferably material passes out of the sorting station on the terminal portion.

Preferably the unsorted material transfer means is arranged to carry material out through the material exit of the sorting station.

Preferably the unsorted material transfer means comprises a terminal position.

Preferably the unsorted material transfer means is arranged to carry material towards the terminal position.

Preferably in use, a storage means is locatable beneath the terminal position. Advantageously, any material which has not been separated from the material stream is collected in this storage means.

Ideally the mobile material sorting apparatus comprises optical sorting means. By “optical sorting means” it is meant a means for sorting material in a material stream which uses electromagnetic radiation such as light, a laser, near-infrared radiation and/or infrared radiation to identify items to be separated.

Preferably the material separation means comprises optical sorting means.

Preferably the mobile sorting apparatus comprises an optical sorting means mounted directly or indirectly on tracks or wheels. Advantageously, the tracks or wheels allow the optical sorting means to be maneuvered on or around a site.

Ideally the mobile sorting apparatus is a tracked optical sorter.

Preferably the sorting station comprises optical sorting means.

Preferably the optical sorting means is at least partially located within the sorting station.

Preferably the optical sorting means is at least partially located within the sorting station housing.

Preferably the optical sorting means comprises an air supply means, a sensing means and/or a pneumatic separation means.

Preferably the optical sorting means comprises an air supply means.

Preferably the air supply means is located within the sorting station.

Optionally the air supply means is located outside the sorting station.

Optionally the air supply means is located under the floor or on the roof of the sorting station.

Preferably the air supply means is located above the conveyor.

Preferably the air supply means is located on a frame.

Preferably gas from the air supply means can be used to create jets of gas which are able to move/deflect items in the material stream. Advantageously, the ability to move/deflect items in the material stream allows for the automated sorting of materials in the material stream.

Preferably gas from the air supply means can be used to create jets of gas which are able to move/deflect items in the material stream as they fall off the end of the unsorted material transfer means.

Preferably the air supply means comprises a source of compressed gas.

Preferably the air supply means comprises a gas cylinder, receiver or tank and/or a compressor.

Preferably the cylinder, receiver or tank is operable to store compressed gas such as air.

Preferably the cylinder, receiver or tank is operable to output said gas in bursts and/or a steady stream.

Preferably the compressor is operable to compress air to replenish the gas cylinder.

Preferably the optical sorting means comprises a sensing means.

Preferably the sensing means is located within the sorting station.

Preferably the sensing means is located above the conveyor.

Preferably the sensing means is located on a frame.

Preferably the sensing means comprises one or more sensors.

Preferably the sensing means comprises one or more optical, infrared and/or near infrared sensors.

Preferably the sensing means comprises one or more sensors configured to sense properties of items in the material stream.

Preferably the sensing means comprises one or more sensors configured to identify certain categories of items in the material stream.

Ideally the sensing means is a scanner. Advantageously, the scanner is able to identify the positions and categories of multiple items across the width of a material stream.

Preferably the sensing means is a scanner for mapping the types (i.e. categories) and locations of items in the material stream.

Preferably the sensing means comprises a source of light and a rotating mirror assembly and/or a rotating light assembly.

Preferably the sensing means comprises an optical sensor such as a near infra-red (NIR) sensor.

Preferably the sensing means is an optical, near infrared or infrared scanner.

Preferably in use items in the material stream are carried towards and pass under the sensing means.

Preferably sensor data is used to determine the type of material located on the unsorted material transfer means.

Preferably sensor data is used to determine the position of material located on the unsorted material transfer means.

Preferably the optical sorting means comprises a processing means.

Preferably the processing means is adapted to receive data from the sensing means.

Preferably the processing means is adapted to send data such as commands to the pneumatic separation means.

Preferably the processing means is configured to identify the category of one or more objects in the material stream.

Preferably the processing means is configured to identify the category of one or more objects in the material stream from received sensor data.

Preferably the processing means is configured to receive sensor data.

Preferably the processing means uses sensor data to determine the type of material located on the conveyor and its position on the conveyor.

Preferably the processor is configured to determine the type and location of items in the material stream that are present on the conveyor underneath the sensing means.

Preferably the processor is configured to determine the type and location of items in the material stream that are present underneath the sensing means before said items reach the pneumatic separation means.

Preferably the optical sorting means comprises pneumatic separation means.

Preferably the pneumatic separation means is at least partially located within the housing.

Preferably the pneumatic separation means is located above or below at least part of at least one material transfer means.

Preferably the pneumatic separation means comprises a housing.

Preferably the pneumatic separation means comprises a housing into which material can pass from the unsorted material transfer means.

Preferably the pneumatic separation means comprises air ejection means.

Preferably the air ejection means comprises one or more apertures or nozzles through which compressed air can be ejected.

Preferably the air ejection means comprises one or more apertures or nozzles through which compressed air can be ejected towards items in the material stream.

Preferably the air ejection means is arranged such that as items pass over the terminal position of the unsorted material transfer means they will pass over or under at least part of the air ejection means, particularly the apertures or nozzles.

Preferably the apertures or nozzles are arranged across the entire width of the end of the unsorted material transfer means.

Preferably the air ejection means is located at the terminal position of the unsorted material transfer means.

Preferably the pneumatic separation means comprises a housing.

Preferably items on the conveyor enter the housing of the pneumatic separation means before reaching the air ejection means.

Preferably in use one or more items pass over the air ejection means.

Preferably the air ejection means is located within the housing of the pneumatic separation means.

Preferably in use one or more items are permitted to fall under the force of gravity towards a first sorted material transfer means.

Preferably the air ejection means is configured to eject a burst or jet of air.

Preferably the air ejection means is configured to eject a burst or jet of air from at least one aperture or nozzle located directly below or above an item.

Preferably the air ejection means is operable to eject bursts or jets of air towards items in the material stream.

Preferably the air ejection means is operable to eject bursts or jets of air towards items in the material stream as said items pass over the end of the unsorted material transfer means.

Preferably the bursts or jets of air can be used to cause said items to follow a predetermined trajectory.

Preferably the bursts or jets of air can be used to cause said items to follow a predetermined trajectory towards the second sorted material transfer means.

Preferably the bursts or jets of air can be used to cause said items to follow a predetermined trajectory away from a sorted material transfer means.

Preferably the optical sorting means is adapted for allowing at least one predetermined category of materials to be separated from the material stream.

Ideally the material separation means comprises a magnetic separation means.

Preferably the magnetic separation means is adapted to separate magnetic/ferrous material from the material stream.

Preferably in use, magnetic/ferrous material in the material stream is attracted towards the magnetic separation means.

Preferably the magnetic separation means comprises a rotating belt.

Preferably the rotating belt is adapted to carry magnetic/ferrous material away from the material stream.

Preferably the rotating belt is adapted to carry magnetic/ferrous material towards a chute and/or a storage means.

Preferably the magnetic separation means is used to separate ferrous/magnetic material from other material in the material stream.

Preferably the magnetic separation means comprises a frame.

Preferably the magnetic separation means comprises a frame which is attached to the sorting station and/or the support chassis and/or conveyor.

Preferably the magnetic separation means is located outside of the sorting station.

Preferably the magnetic separation means is located outside of the sorting station housing.

Preferably the magnetic separation means is located between the material exit of the sorting station and the terminal position of the unsorted material transfer means.

Preferably the magnetic separation means is located downstream from the sorting station.

Preferably the magnetic separation means is located upstream from the terminal position of the unsorted material transfer means.

Preferably the magnetic separation means is located above the unsorted material transfer means, in use.

Optionally the mobile material sorting apparatus comprises a screening means such as a screen or trommel.

Preferably the unsorted material transfer means is located at least partially within the sorting station housing.

Preferably the unsorted material transfer means is adapted to carry material through the sorting station from the material entrance to the material exit.

Preferably in use, the material stream travels from the intake means towards the terminal position of the unsorted material transfer means.

Ideally the mobile material sorting apparatus comprises an exit conveyor.

Optionally the mobile material sorting apparatus comprises an inclined or horizontal exit conveyor.

Preferably the exit conveyor is adapted to carry material in the material stream.

Preferably the exit conveyor is adapted to carry material which passes over the end of the terminal portion of the unsorted material transfer means.

Preferably the exit conveyor is adapted to carry material in the material stream past one or more material separation means.

Preferably the exit conveyor is adapted to carry material in the material stream past the magnetic separation means and/or the air separation means.

Preferably the air separation means is located towards the distal end of the exit conveyor.

Ideally the mobile material sorting apparatus comprises at least one sorted material transfer means.

Preferably the mobile material sorting apparatus comprises a plurality of sorted material transfer means.

Preferably the mobile material sorting apparatus comprises first and second sorted material transfer means.

Preferably the or each sorted material transfer means is adapted to transfer an item to an appropriate location outside the mobile material sorting apparatus.

Preferably the or each sorted material transfer means is adapted to transfer an item to an appropriate location outside the sorting station.

Preferably the or each sorted material transfer means is adapted to guide an item towards a storage means.

Preferably the or each sorted material transfer means is adapted to guide an item towards a storage means located outside the mobile material sorting apparatus.

Preferably the or each sorted material transfer means comprises a picking bin and/or chute.

Preferably the or each picking bin and/or chute comprises an aperture.

Preferably the or each picking bin and/or chute comprises an aperture which passes through the sorting station and/or housing.

Preferably the or each picking bin and/or chute comprises an aperture which passes through the floor, side wall or end wall of the housing.

Preferably the or each picking bin and/or chute provides a path for items to exit the sorting station and/or housing.

Optionally storage means are locatable under the exits of the or each picking bin and/or chute. Advantageously, such storage means are able to collect material which has been separated out from the material stream and placed into the picking bin and/or chute by an operative and/or another means for example a robot or optical sorting means.

Optionally sorted material transfer means such as conveyor means are locatable under the exits of the or each picking bin and/or chute.

Preferably the or each sorted material transfer means comprises a conveyor means.

Preferably the or each sorted material transfer means comprises a lateral conveyor means.

Preferably the conveyor means is at least partially locatable below the material separation means.

Preferably the conveyor means is at least partially locatable below the sorting station.

Preferably the conveyor means is at least partially locatable below a picking bin and/or chute.

Preferably the conveyor means is at least partially locatable below the aperture of a picking bin and/or chute collection to picking bin.

Preferably the conveyor means is at least partially locatable below the aperture of the picking bin and/or chute.

Preferably the conveyor means is at least partially locatable above the transportation means.

Preferably the conveyor means is at least partially locatable between the sorting station and the transportation means.

Preferably the conveyor means is at least partially locatable between the floor of the sorting station and the transportation means.

Preferably the conveyor means is at least partially locatable between the floor of the sorting station and the endless tracks of the transportation means.

Preferably at least one sorted material transfer means is at least partially locatable below the optical sorting means.

Preferably at least one sorted material transfer means is at least partially locatable below the housing of the optical sorting means.

Preferably the or each sorted material transfer means comprises a stockpile conveyor.

Preferably the or each stockpile conveyor is adapted to transfer items to a respective storage means.

Preferably the or each stockpile conveyor is adapted to transfer items from a picking bin/chute to a respective storage means.

Preferably the or each stockpile conveyor comprises an intake portion.

Preferably the or each stockpile conveyor comprises an intake portion locatable below a picking bin/chute.

Preferably the or each intake portion is substantially horizontal in use.

Optionally the or each intake portion is inclined in use.

Preferably the or each intake portion is substantially flat.

Preferably the or each intake portion is generally parallel to the floor of the housing.

Preferably the or each stockpile conveyor comprises a transfer portion.

Preferably the or each transfer portion is adjacent to the intake portion.

Preferably the or each transfer portion is horizontal or inclined, in use.

Preferably the or each transfer portion is located proximally to the intake portion such that items on the stockpile conveyor are able to move from the intake portion to the transfer portion.

Preferably the or each stockpile conveyor comprises a frame.

Preferably the or each stockpile conveyor comprises a frame which is attached to the sorting station, housing and/or the support chassis.

Preferably the or each stockpile conveyor comprises an endless belt which rotates to carry material thereon.

Optionally the or each stockpile conveyor is foldable and/or telescopic. Advantageously, the or each stockpile conveyor can be folded away and/or stored in a compact configuration during transport.

Preferably the or each stockpile conveyor is foldable for transport.

Preferably the or each stockpile conveyor comprises a transport position.

Preferably the or each stockpile conveyor is folded/retracted in the transport position.

Preferably in the transport position a peripheral end of the stockpile conveyor is located adjacent to the mobile material sorting apparatus.

Preferably in the transport position a peripheral end of the stockpile conveyor is located adjacent to the housing of the mobile material sorting apparatus.

Preferably the or each stockpile conveyor is in the transport position during transport.

Preferably the or each stockpile conveyor has a deployment position.

Preferably the or each transfer portion extends away from the mobile material sorting apparatus in the deployment position.

Preferably the or each transfer portion extends away from the mobile material sorting apparatus horizontally or at an angle in the deployment position.

Preferably the or each stockpile conveyor is movable to the deployment position when the mobile material sorting apparatus is located at a suitable on-site position.

Preferably the or each stockpile conveyor is moved to the deployment position when it is ready to be used.

Preferably the or each stockpile conveyor is in the deployment position during use.

Preferably in use, the or each transfer portion passes over the peripheral edge of a storage means.

Preferably in use, the distal end of each stockpile conveyor extends over the wall of a storage bay.

Preferably in use, the distal end of each stockpile conveyor extends over the wall of a storage bay such that items carried on the stockpile conveyor can pass over the distal end thereof and fall into the storage bay.

Preferably the or each stockpile conveyor is adapted to create and/or add to a stockpile.

Preferably the or each stockpile conveyor is adapted to carry material towards a stockpile and/or another means such as a shredder or separation means.

Preferably a stockpile is locatable underneath and/or adjacent to a distal end of one or more stockpile conveyors.

Optionally one or more stockpile conveyors are adapted to carry material towards one or more further conveyor means.

Optionally a stockpile is locatable underneath and/or adjacent to a distal end of one or more further conveyor means.

Preferably the or each further conveyor means is adapted to carry material towards a stockpile and/or another means such as a shredder or separation means.

Preferably the direction of the material stream through the mobile material sorting apparatus is substantially parallel to the major axis of the material sorting apparatus.

Preferably the mobile material sorting apparatus has a major axis.

Preferably the major axis is parallel to the longest dimension of the mobile material sorting apparatus.

Preferably the direction of the unsorted material carried on the picking conveyor is substantially parallel to the major axis of the mobile material sorting apparatus.

Preferably the major axis of the mobile material sorting apparatus is substantially parallel to the longest dimension of the mobile material sorting apparatus.

Preferably the major axis of the mobile material sorting apparatus is substantially parallel to the longest dimension of the housing of the sorting station.

Preferably the direction of sorted material as it passes out of the mobile material sorting apparatus via a sorted material transfer means is at an angle with respect to the direction of the unsorted material stream through the mobile material sorting apparatus.

Preferably the direction of sorted material as it passes out of the mobile material sorting apparatus via a sorted material transfer means is skewed with respect to the direction of the unsorted material stream through the mobile material sorting apparatus.

Preferably the direction of sorted material as it passes out of the mobile material sorting apparatus via a sorted material transfer means is substantially perpendicular to the direction of the unsorted material stream through the mobile material sorting apparatus. Advantageously, the layout and design of the mobile material sorting apparatus ensures its compactness compared to prior art systems.

According to a fourth aspect of the invention there is provided a method of sorting material in a material stream, the method comprising using the mobile material sorting apparatus to sort material in the material stream.

Preferably the method comprises transporting the mobile material sorting apparatus to a site.

Preferably the method comprises transporting the mobile material sorting apparatus to a site using a truck or lorry trailer.

Preferably the method comprises transporting the mobile material sorting apparatus to a site under its own motive force using the transport means.

Preferably the method comprises transporting the mobile material sorting apparatus to a position on a site.

Preferably the method comprises locating the mobile material sorting apparatus proximally to one or more storage means and/or stockpiles.

Preferably the method comprises locating the mobile material sorting apparatus proximally to one or more stockpiles, skips, cages, bays or silos.

Preferably the method comprises locating one or more storage means and/or stockpiles proximally to the mobile material sorting apparatus.

Preferably the method comprises locating one or more storage means and/or stockpiles proximally to one or more sorted material transfer means of the mobile material sorting apparatus. Preferably the method comprises deploying the one or more sorted material transfer means.

Preferably the method comprises moving the one or more sorted material transfer means from a transport position to a deployment position.

Preferably the method comprises aligning the sorted material transfer means with the storage means.

Preferably the method comprises aligning the outlets of the sorted material transfer means with the storage means.

Preferably the method comprises inputting material to the material intake means.

Preferably the method comprises inputting a material stream.

Preferably the method comprises activating one or more conveyor means.

Preferably the method comprises using one or more material sorting means to separate categories of material from the material stream.

Preferably the method comprises using one or more sorted material transfer means to transfer items separated from the material stream to one or more storage means.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The invention will now be described with reference to the accompanying drawings which show, by way of example only, six embodiments of an apparatus in accordance with the invention.

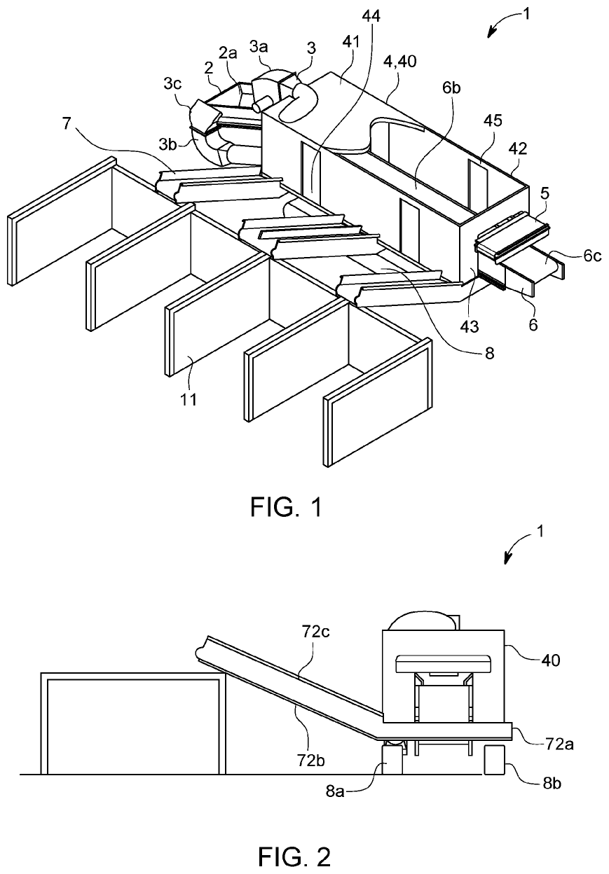

FIG. 1 is a perspective view of a mobile material sorting apparatus according to an aspect of the invention and a storage arrangement.

FIG. 2 is an end view of the mobile material sorting apparatus and storage arrangement shown in FIG. 1.

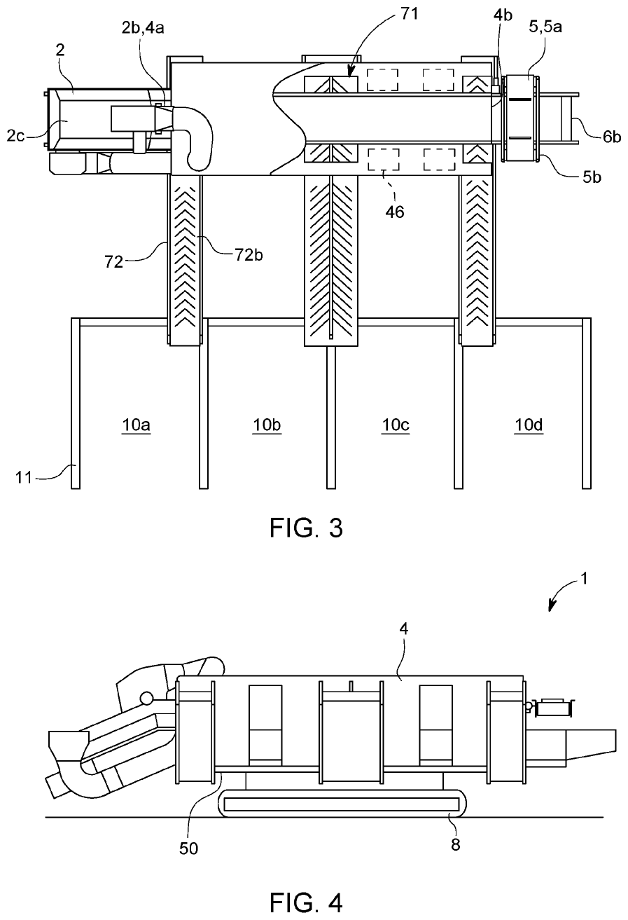

FIG. 3 is a plan view of the mobile material sorting apparatus and storage arrangement shown in FIG. 1.

FIG. 4 is a side view of the mobile material sorting apparatus shown in FIG. 1.

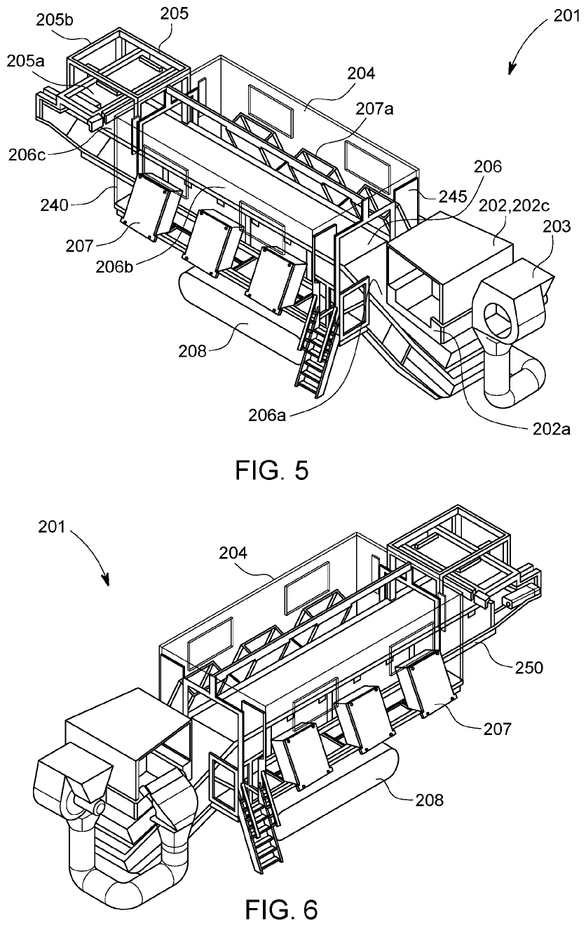

FIG. 5 is a perspective view of a second mobile material sorting apparatus according to an aspect of the invention.

FIG. 6 is an alternative perspective view of the mobile material sorting apparatus shown in FIG. 5.

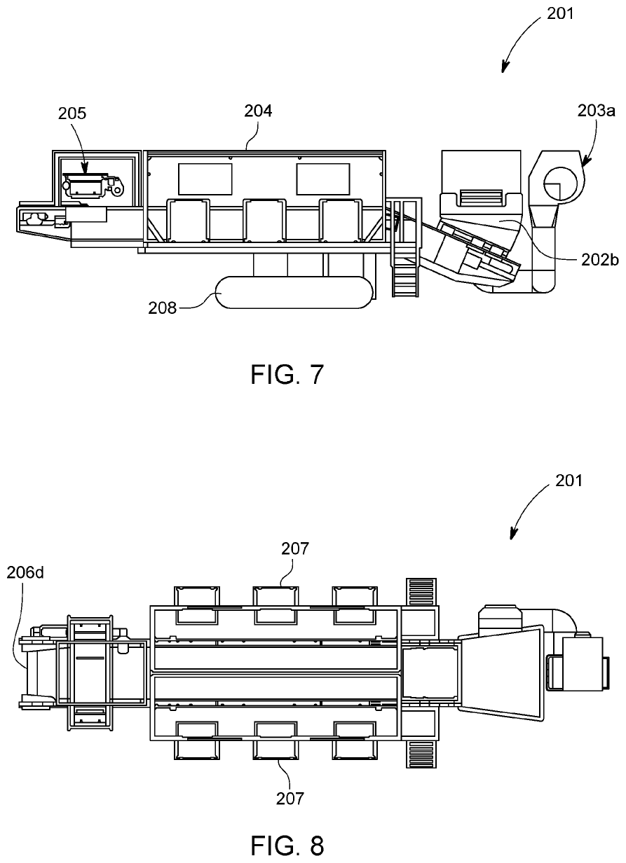

FIG. 7 is a side view of the mobile material sorting apparatus shown in FIG. 5.

FIG. 8 is a plan view of the mobile material sorting apparatus shown in FIG. 5.

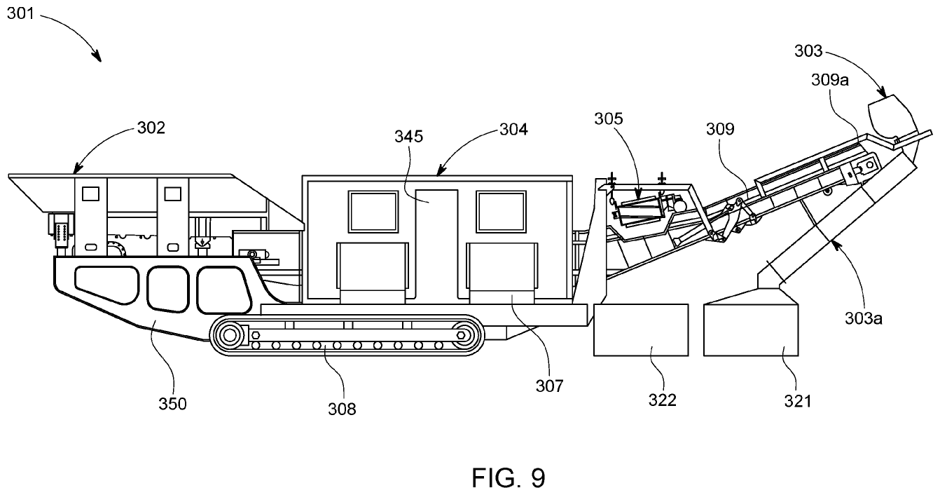

FIG. 9 is a side view of a third mobile material sorting apparatus according to an aspect of the invention.

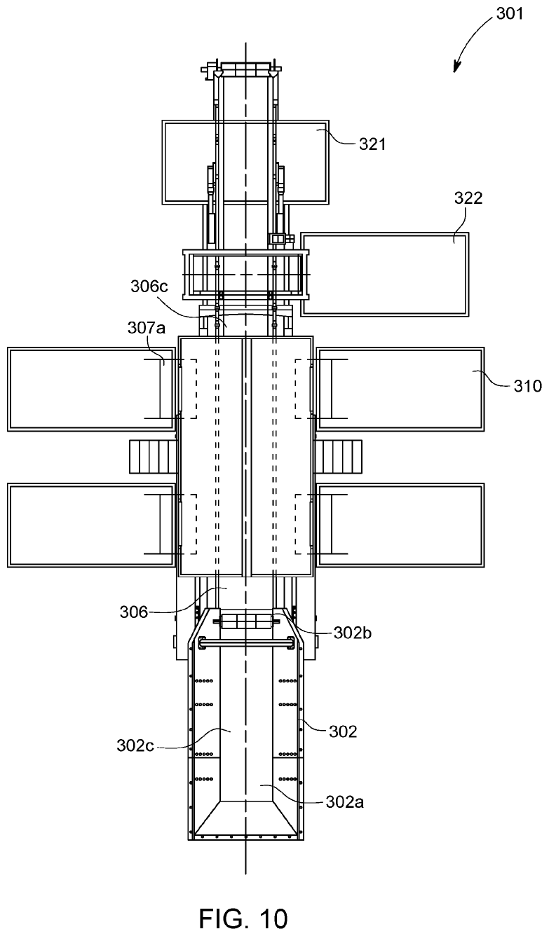

FIG. 10 is a plan view of the mobile material sorting apparatus shown in FIG. 9.

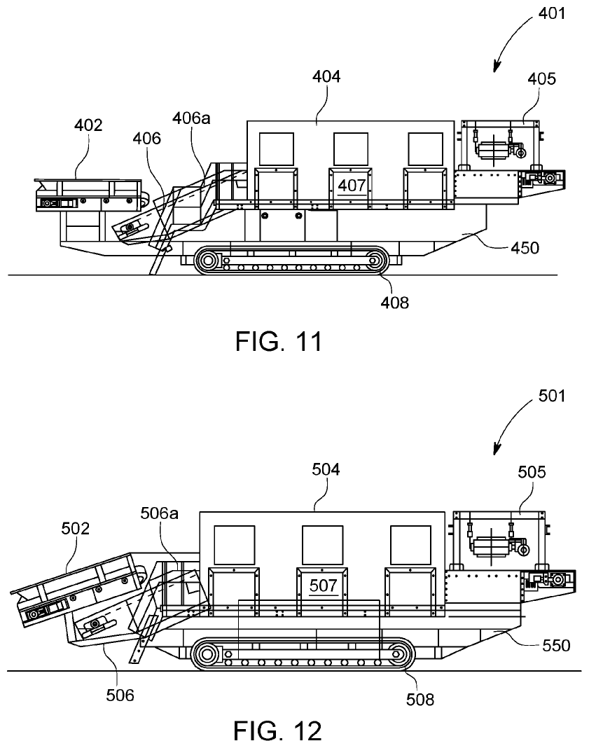

FIG. 11 is a side view of a fourth mobile material sorting apparatus according to an aspect of the invention.

FIG. 12 is a side view of a fifth mobile material sorting apparatus according to an aspect of the invention.

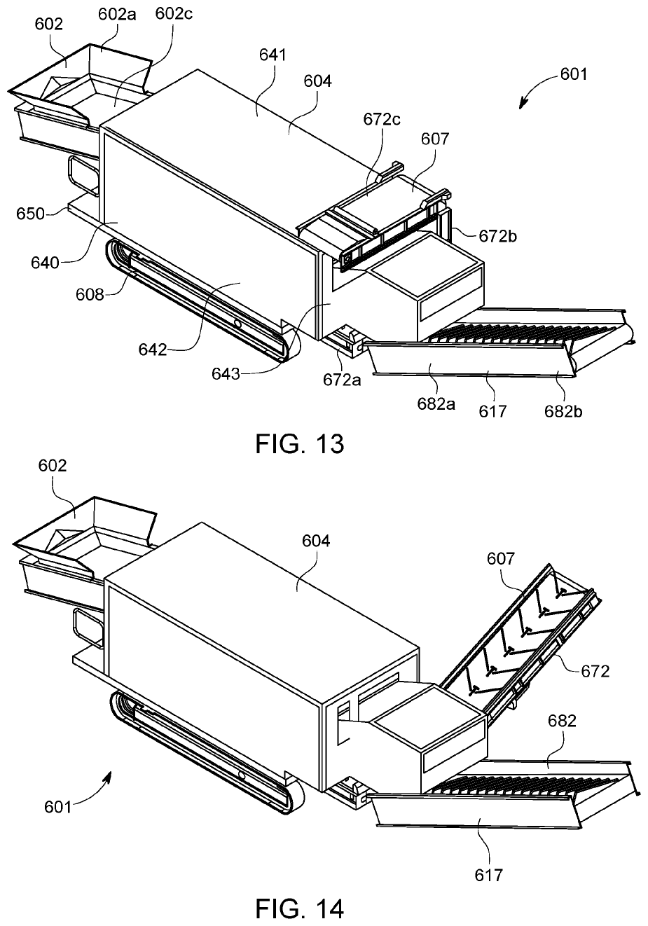

FIG. 13 is a perspective view of a sixth mobile material sorting apparatus according to an aspect of the invention.

FIG. 14 is a further perspective view of the mobile material sorting apparatus shown in FIG. 13.

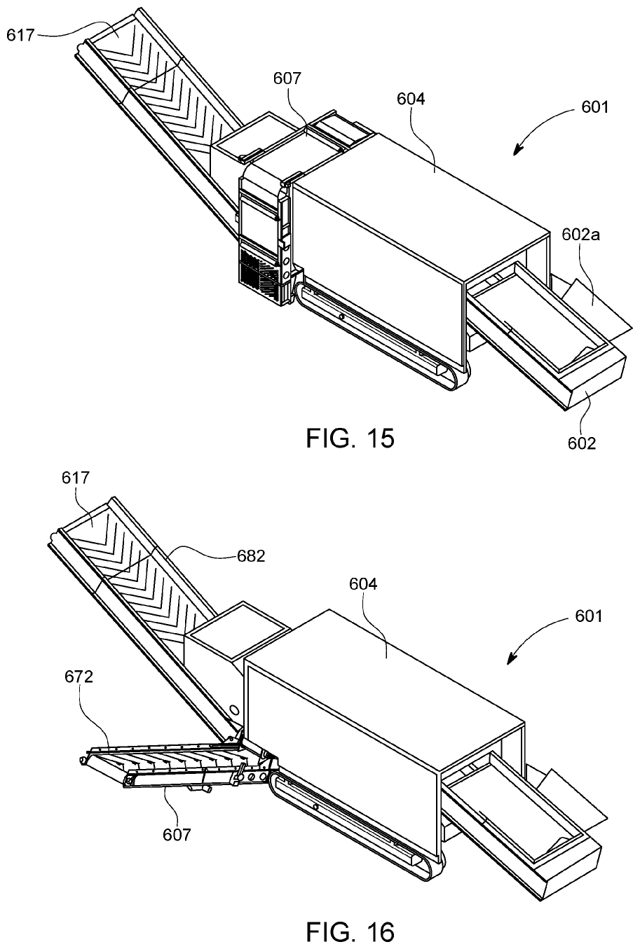

FIG. 15 is a further perspective view of the mobile material sorting apparatus shown in FIG. 13.

FIG. 16 is a further perspective view of the mobile material sorting apparatus shown in FIG. 13.

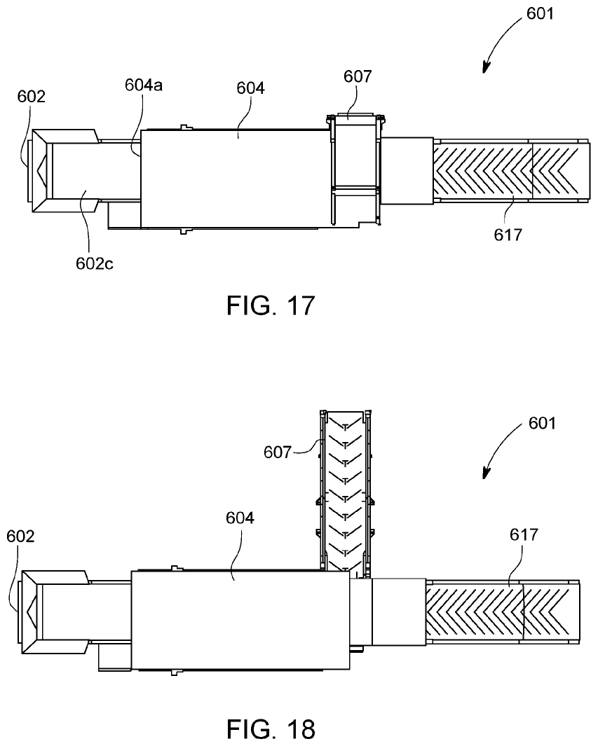

FIG. 17 is a plan view of the mobile material sorting apparatus shown in FIG. 13.

FIG. 18 is a further plan view of the mobile material sorting apparatus shown in FIG. 13.

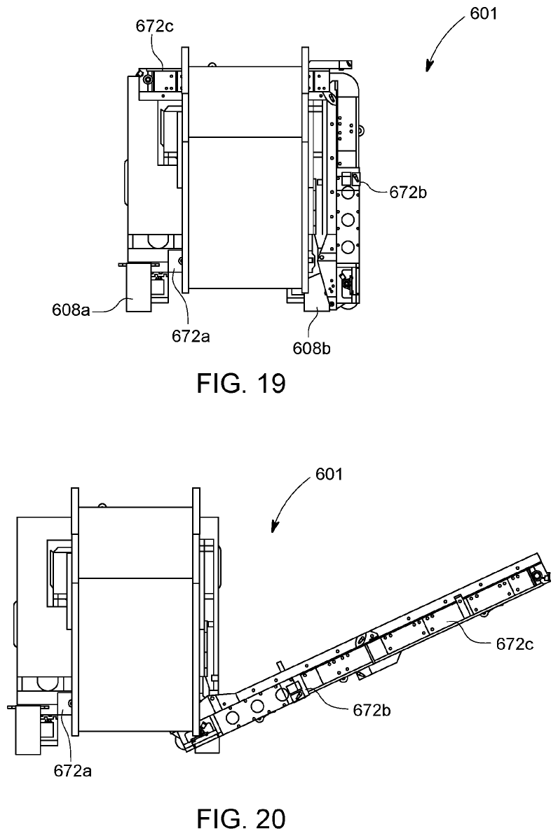

FIG. 19 is an end view of the mobile material sorting apparatus shown in FIG. 13.

FIG. 20 is a further end view of the mobile material sorting apparatus shown in FIG. 13.

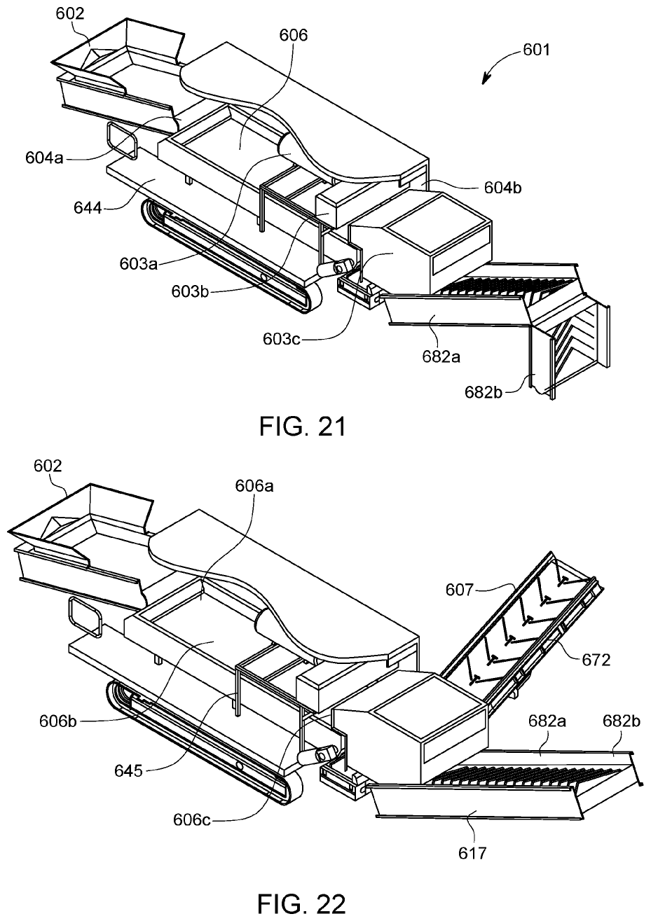

FIG. 21 is a cutaway perspective view of the mobile material sorting apparatus shown in FIG. 13.

FIG. 22 is a further cutaway perspective view of the mobile material sorting apparatus shown in FIG. 13.

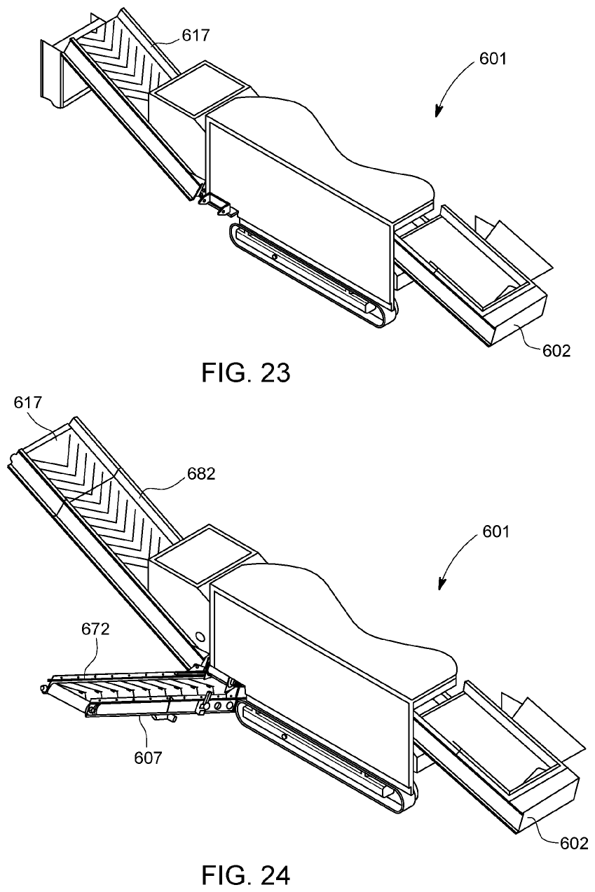

FIG. 23 is a further cutaway perspective view of the mobile material sorting apparatus shown in FIG. 13.

FIG. 24 is a further cutaway perspective view of the mobile material sorting apparatus shown in FIG. 13.

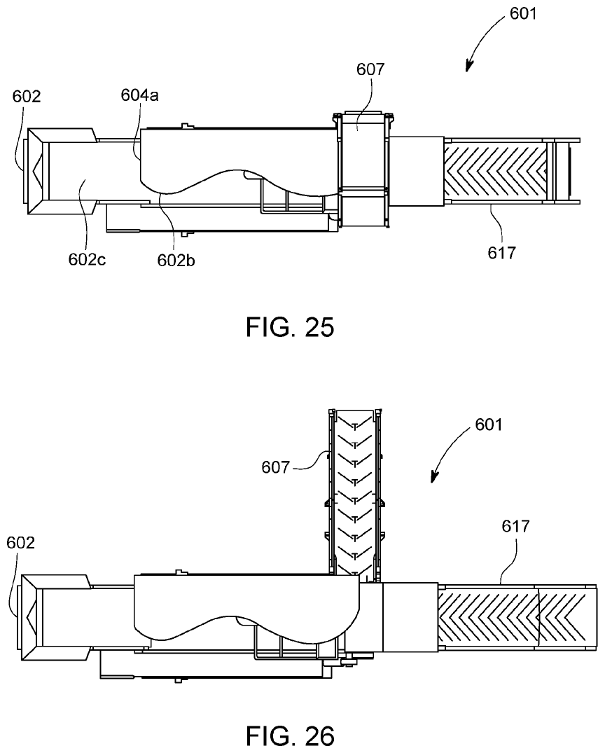

FIG. 25 is a cutaway plan view of the mobile material sorting apparatus shown in FIG. 13.

FIG. 26 is a further cutaway plan view of the mobile material sorting apparatus shown in FIG. 13.

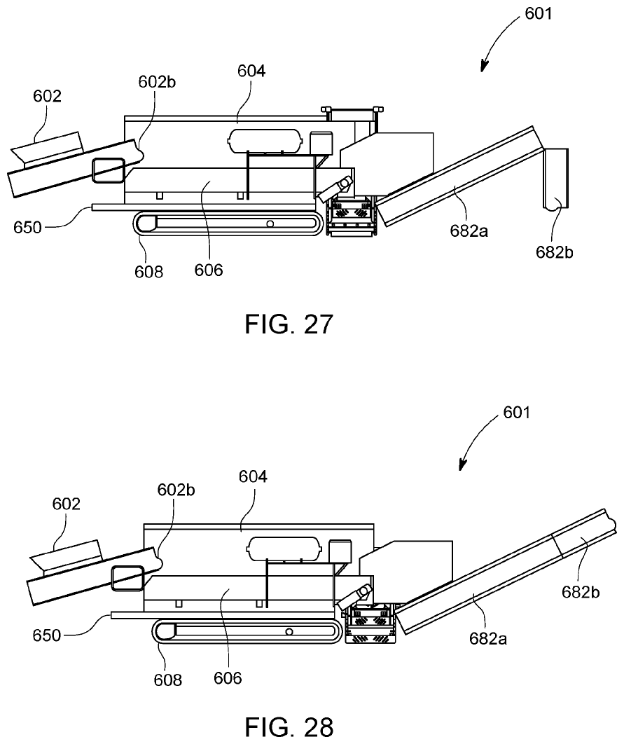

FIG. 27 is a cutaway side view of the mobile material sorting apparatus shown in FIG. 13.

FIG. 28 is a further cutaway side view of the mobile material sorting apparatus shown in FIG. 13.

In FIG. 1 there is shown a mobile material sorting apparatus 1 according to the invention. The mobile material sorting apparatus 1 comprises: a material intake arrangement 2; a plurality of material separation arrangements 3-5; an unsorted material transfer arrangement 6; a plurality of sorted material transfer arrangements 7; and a transportation arrangement 8. In the embodiment shown in FIGS. 1-4 the plurality of material separation arrangements comprise an air separation arrangement 3, a sorting station 4 and a magnetic separation arrangement 5. When deployed, the mobile material sorting apparatus 1 is used to sort materials in a material stream. The mobile material sorting apparatus 1 is optionally a waste sorting apparatus i.e. an apparatus for separating materials in a waste stream. As will be appreciated, the present invention is not limited to waste sorting only and can be employed in many diverse situations where streams of mixed material are to be separated and sorted.

The material intake arrangement 2 comprises an entrance 2a for receiving material, for example waste material from e.g. a building or domestic site, or any other material to be sorted. Material can be placed into the intake arrangement 2 via the entrance 2a using e.g. an excavator. The material intake arrangement 2 comprises an outlet 2b (shown in FIG. 3) for allowing material placed into the intake arrangement 2 to move out of the material intake arrangement 2 and towards at least some of the material separation arrangements, particularly the sorting station 4 and the magnetic separator 5.

The material intake arrangement 2 comprises an inclined feed conveyor 2c. The feed conveyor 2c is adapted to transport material in the material intake arrangement 2 towards the outlet arrangement 2b i.e. towards the exit of the material intake arrangement 2 and towards the sorting station 4. Material in the material stream passes an air separator 3 as it passes along the feed conveyor 2c (shown in FIG. 3) or as the material falls/passes between the inlet 2a and outlet 2b. The air separator 3 comprises an air-flow generator 3a in the form of a fan or blower, ductwork 3b and an outlet 3c. The air separator 3 is adapted to generate a flow of air towards material in the material stream as it passes into the material intake arrangement 2 and as it falls/passes the blower outlet 3c and travels along the feed conveyor towards the outlet of the intake arrangement 2.

The air separator 3 is adapted to separate low density/lighter material from other materials in the material stream by providing a flow of air which directs such material towards a storage arrangement and/or a chute (not shown). The storage arrangement may be a skip, cage, bay or silo. In the embodiment of FIGS. 1-4 the air separator 3 is mechanically coupled to the intake arrangement 2. The feed conveyor 2c is adapted to transport material not separated from the material stream by the air separator 3 out of the intake arrangement 2. The feed conveyor 2c is located generally below the outlet 3c of the air separator 3.

The mobile material sorting apparatus 1 comprises an unsorted material transfer arrangement 6. The unsorted material transfer arrangement 6 is a picking conveyor which passes through the sorting station 4. The picking conveyor 6 comprises an input portion 6a (not shown), a central portion 6b and a terminal portion 6c. Material which exits the intake arrangement 2 falls or is transferred onto the input portion 6a where it is carried towards the sorting station 4. Material is carried through the sorting station 4 on the central portion 6b before passing out of the sorting station 4 to the terminal portion 6c. The picking conveyor 6 comprises a frame which is attached to the housing and/or the support chassis 50. The frame passes through the housing 40 of the sorting station 4. The picking conveyor 6 comprises an endless belt which rotates to carry material thereon. As will be appreciated, the picking conveyor 6 can be made up of a plurality of consecutive conveyor belts and may carry material in either direction through the apparatus 1.

The sorting station 4 is a manual separation arrangement i.e. an arrangement adapted to allow the manual separation of items from the material stream. In this embodiment the sorting station is a manual picking station in which operatives manually pick out certain items from a material stream. However, it is envisaged that the sorting station can comprise robotic, optical, near-infrared or air sorting arrangements. For example, one or more robotic arms located within the housing 40 may be used to manually pick out certain items from the material stream as the stream is carried along the picking conveyor 6.

The sorting station 4 comprises a housing 40 having a roof 41 (partially cut away in FIGS. 1 and 3), two side walls 42, two end walls 43 and a floor 44. In the example embodiment of FIGS. 1-4, one or more operatives located within the housing 40 are able to pick items from the material stream while the stream passes through the housing 40 on the picking conveyor 6. Operatives can enter the housing 40 through personnel access doors 45 located in side walls of the housing 40. The personnel access doors 45 are accessible from the ground via a ladder (not shown) or a set of stairs or other suitable means.

The sorting station 4 is a multi-bay sorting station. Eight picking positions, such as picking position 46 shown in FIG. 3, are located inside the sorting station 4 for manual picking of items in the material stream. One or more operatives may be located at each picking position. The sorting station 4 may be arranged to include e.g. two picking positions for manual picking of wooden items in the material stream, and two picking positions for manual picking of plastic items in the material stream. As will be appreciated, the particular categories of items that are to be picked at each position can be varied and will be largely determined by the categories of material in the material stream. Each operative may be tasked with picking a different category of items from the material stream.

The sorting station 4 comprises a material entrance 4a through which material can enter the sorting station 4 from the intake arrangement 2. The material entrance 4a is located in an end wall 43 of the housing 40. The sorting station 4 comprises a material exit 4b through which unsorted/unpicked material in the material stream can exit the sorting station 4. The material exit 4b is located in an opposing end wall 43 of the housing 40. The picking conveyor 6 is located at least partially within the housing 40 and is adapted to carry material through the sorting station from the material entrance 4a to the material exit 4b.

In use, operatives located inside the sorting station 4 are able to pick or lift items from the material stream as it is carried through the sorting station 4 on the picking conveyor 6. Once removed from the material stream/conveyor 6, said items are transferred by the operative to an appropriate sorted material transfer arrangement 7. Each sorted material transfer arrangement 7 is adapted to transfer an item to an appropriate location outside the sorting station 4 to a place where said sorted item may be stored, for example with other items in the same material category. Material not picked out of the material stream by operatives passes out of the sorting station 4 via the material exit 4b. The picking conveyor 6 is arranged to carry material out through the material exit 4b towards a terminal position 6d. In use, a storage bay may be located beneath the terminal position so that any material which has not been separated from the material stream falls into such a storage bay.

In the embodiment of FIGS. 1-4, each sorted material transfer arrangement 7 comprises a picking bin/chute 71. Each picking bin/chute 71 comprises an aperture passing through the floor 44 of the housing 40, and provides a path for items to exit the housing 40. Each sorted material transfer arrangement 7 further comprises a stockpile conveyor 72 at least partially locatable below the sorting station 4. Each stockpile conveyor 72 is adapted to transfer picked items which are passed through a chute 71 to a respective storage arrangement, in this case a bay 10. The apparatus 1 comprises a plurality of sorted material transfer arrangements 7 via which picked material (in this example, wood and plastic) can pass from the sorting station 4 and into the storage bays 10a-d.

Each stockpile conveyor 72 comprises an intake portion 72a located directly below a picking bin/chute 71, and a transfer portion 72b. Each intake portion 72a is located below the sorting station 4 and between the floor of the sorting station and the endless tracks of the transportation arrangement. In the illustrated embodiment of FIGS. 1-4 the intake portion 72a is substantially flat and parallel to the floor of the housing 40, and each transfer portion 72b is inclined to pass over the wall 11 of a bay 10 (see FIG. 2). While in this embodiment the intake portion 72a is substantially horizontal in use, in further contemplated embodiments the intake portion 72a may be inclined in use.

Ideally each stockpile conveyor is foldable and/or telescopic for transport purposes. Each stockpile conveyor 72 comprises a frame 72c which is attached to the housing 40, and an endless belt which rotates to carry material thereon. In the disclosed embodiments each stockpile conveyor 72 carries material in a direction which is substantially perpendicular to the direction along which material is carried along the picking conveyor 6. In alternative embodiments the stockpile conveyors may be disposed at a different angle compared to the picking conveyor 6. Each stockpile conveyor 72 is movable between a transport position and a deployment position.

In the deployment position (shown in e.g. FIG. 2) each transfer portion 72b extends away from the mobile material sorting apparatus 1 at an angle. In the example of FIGS. 1-3 the distal end of each stockpile conveyor 72 extends over the wall of a storage bay 10 such that items carried on the stockpile conveyor 72 can pass over the distal end thereof and fall into the storage bay 10, forming and/or adding to a stockpile therein. As will be appreciated, stockpiles can be created at any suitable position on a site. A stockpile can be created underneath the distal end of one or more of the stockpile conveyors 72. Alternatively or additionally one or more further conveyors may be located underneath the distal end of a stockpile conveyor 72, in order to carry material towards a stockpile and/or another apparatus such as a shredder or separation arrangement.

In the transport position, the stockpile conveyor is folded and/or retracted such that the end of the stockpile conveyor is moved towards the mobile material sorting apparatus 1, particularly the housing 40. Each stockpile conveyor 72 is preferably in the transport position during transport and is moved to the deployment position when it is ready to be used and during use.

The mobile material sorting apparatus 1 comprises a magnetic separator 5. In the embodiment of FIGS. 1-4 the magnetic separator 5 is located between the material exit 4b and the terminal position 6d of the picking conveyor 6. The magnetic separator 5 is used to separate ferrous/magnetic material from other material in the material stream. In this embodiment the magnetic separator 5 is located downstream from the sorting station 4, upstream from the terminal position 6d of the picking conveyor 6 and above the picking conveyor 6. The magnetic separator 5 comprises a frame 5b which is attached to a conveyor frame or the support chassis of the material sorting apparatus 1. In use, magnetic/ferrous material in the material stream travelling on the conveyor 6 is attracted towards the magnetic separator 5. The magnetic separator 5 comprises a rotating belt 5a which is adapted to carry magnetic/ferrous material away from the picking conveyor 6. A chute (not shown) may be used to guide magnetic/ferrous material towards a storage arrangement such as a skip or stockpile located underneath the outlet of the chute.

Each material separation arrangement 3-5 is adapted for allowing at least one predetermined category of materials to be separated from the material stream. The material stream travels from the intake arrangement 2 towards the terminal position 6d of the picking conveyor 6. Upstream directions are towards the intake arrangement 2 and downstream directions are towards the terminal position 6d of the picking conveyor 6.

The mobile material sorting apparatus 1 comprises a transportation arrangement 8. The transportation arrangement 8 allows the mobile material sorting apparatus 1 to move around a site. The transportation arrangement 8 comprises two track assemblies 8a, 8b. Each track assembly 8a,8b comprises a plurality of wheels and an endless track disposed around the wheels. The endless track engages the ground to provide traction and is moved by the wheels to provide motion. Each track assembly 8a,8b is used to propel the mobile material sorting apparatus 1. Each track assembly 8a,8b is attached to an elongate chassis 50 on which the sorting station 4 is mounted. The mobile material sorting apparatus 1 can comprise a native power arrangement (not shown), such as a diesel engine, or can be powered by an external power arrangement. Such power arrangements can be used for powering the components such as the transportation arrangement 8, the conveyors 2c,6,72 and the magnetic separator 5.

The operation of the mobile material sorting apparatus 1 is as follows. The mobile material sorting apparatus 1 is transported to a site. As will be appreciated, the mobile material sorting apparatus 1 may be transported to a site using a truck or lorry trailer. Alternatively, the mobile material sorting apparatus 1 may move to the site under its own motive force using the transportation arrangements 8. Upon reaching the site, the mobile material sorting apparatus 1 can move around the site under its own motive power using the transportation arrangements 8.

The mobile material sorting apparatus 1 is located proximally to one or more storage arrangements at the site. In the example of FIG. 1, the storage arrangements are formed of a plurality of walls 11 which form partially enclosed silos/storage bays 10a-10d. As will be appreciated alternative storage arrangements such as stockpiles, skips, containers and/or bins may be used instead of, or in addition to, the static storage arrangements shown in FIGS. 1-3. Once the mobile material sorting apparatus 1 is located in an appropriate position adjacent to the storage bays, the plurality of sorted material transfer arrangements 7 are deployed. The sorted material transfer arrangements 7 are aligned with the storage bays 10a-d.

Once the mobile material sorting apparatus 1 is suitably located and deployed with respect to the on-site storage arrangements, material is input into the intake arrangement 2. Conveyors 2c,6 are activated to cause the material stream to pass the air separator 3, picking positions in the sorting station 4 and the magnetic separator 5. Any material not separated out from the material stream passes over the terminal position 6d of the picking conveyor 6 where it falls under the force of gravity. A container such as a skip or storage container may be located beneath the terminal position 6d to collect this material.

The direction of the material stream through the mobile material sorting apparatus 1, particularly the unsorted material carried on the picking conveyor 6, is substantially parallel to the major axis of the material sorting apparatus 1. In the disclosed embodiments, this is substantially parallel to the longest dimension of the material sorting apparatus 1 and the longest dimension of the housing of the sorting station 4. The direction of sorted material as it passes out of the sorting station 4 via the sorted material transfer arrangements 7 is substantially perpendicular to the direction of the unsorted material stream through the mobile material sorting apparatus 1. The layout and design of the mobile material sorting apparatus 1 ensures its compactness compared to prior art arrangements.

FIGS. 5-7 show a further mobile sorting apparatus 201 according to the invention. The mobile material sorting apparatus 201 of this second embodiment comprises: a material intake arrangement 202; a plurality of material separation arrangements 203-205; an unsorted material transfer arrangement 206; a plurality of sorted material transfer arrangements 207; and a transportation arrangement 208. In the embodiment shown in FIGS. 5 and 6 the plurality of material separation arrangements comprise an air separation arrangement 203, a sorting station 204 and a magnetic separation arrangement 205.

The mobile material sorting apparatus 201 of the second embodiment is of a generally similar construction to the first embodiment 1 shown in FIGS. 1-4 with like numerals (e.g. 8,208) denoting similar components. The operation of the mobile material sorting apparatus 201 is similar to that of the first embodiment. The distinguishing features of the second embodiment are: the form of the material intake arrangement 202; the picking conveyor having an inclined portion 206a; and the form of the sorted material transfer arrangement 207. Other distinguishing features include the location and form of the entry arrangements 245, the frame 205b which holds the magnetic separation means 205, and the design of the support chassis 250 which connects the components together.

The material intake arrangement 202 of the second embodiment comprises entrances 202a for receiving material, specifically front and rear apertures which are located on opposing sides of an intake cover member 202c. The material intake arrangement 202 comprises an outlet 202b for allowing material placed into the intake arrangement 202 to move out of the material intake arrangement 202 and towards an inclined portion 206a of the picking conveyor 206. Material falls through the outlet 202b under the force of gravity and onto an inclined portion 206a of the picking conveyor 206. Material in the material stream passes an air separator 203 as it passes through the intake arrangement 202. The air separator 3 comprises an air-flow generator in the form of a fan or blower 203a. The air separator 203 is adapted to generate a flow of air towards material in the material stream as it travels into the intake arrangement 202 and towards the outlet 202b.

The picking conveyor 206 of the mobile material sorting apparatus 201 comprises an inclined input portion 206a, a central portion 206b and a terminal portion 206c. Material which exits the intake arrangement 202 falls onto the input portion 206a where it is carried towards the sorting station 204. Material is carried through the sorting station 204 on the central portion 206b before passing out of the sorting station 204 to the terminal portion 206c and towards a terminal position 206d.

In the embodiment of FIGS. 5-8, the mobile material sorting apparatus 201 comprises six sorted material transfer arrangements 207. Each sorted material transfer arrangement 207 comprises a chute 207a. Each chute 207a passes through a side wall of the sorting station housing and provides an aperture through which items are able to pass out of the housing. Storage arrangements such as skips (not shown) can be placed directly under the exits of the chutes to collect material which has been separated out from the material stream and placed into the chute by an operative. Alternatively stockpile conveyors are at least partially locatable beneath the sorting station 204, particularly under the exits of the chutes, and may be used to transfer sorted material to suitable storage arrangements. The direction of sorted material as it passes out of the sorting station 204 via the sorted material transfer arrangements 207 is substantially perpendicular to the direction of the unsorted material stream through the mobile material sorting apparatus 201, although in optional embodiments this may be a different angle. The layout and design of the mobile material sorting apparatus 201 ensures its compactness compared to prior art arrangements.

FIGS. 9 and 10 show a further mobile sorting apparatus 301 according to the invention. The mobile material sorting apparatus 301 of this third embodiment comprises: a material intake arrangement 302; a plurality of material separation arrangements 303-305; an unsorted material transfer arrangement 306; a plurality of sorted material transfer arrangements 307; and a transportation arrangement 308. In the embodiment shown in FIG. 9 the plurality of material separation arrangements comprise an air separation arrangement 303, a sorting station 304 and a magnetic separation arrangement 305.

The mobile material sorting apparatus 301 of the third embodiment is again of a generally similar construction to the earlier embodiments with like numerals (e.g. 8,308) denoting similar components. The operation of the mobile material sorting apparatus 301 is similar to that of the earlier embodiments. The distinguishing features of the third embodiment 301 are: the form of the material intake arrangement 302; the use of an inclined exit conveyor 309; the location of the air separation arrangement 303; and the construction of the magnetic separation arrangement 305. The sorted material transfer arrangements 307 are generally similar to those of the second embodiment. Other differences include the location and form of the entry arrangements 345 and the design of the support chassis 350.

The material intake arrangement 302 comprises an entrance 302a for receiving material. Material can be placed into the intake arrangement 302 via the entrance 302a using e.g. an excavator. The material intake arrangement 302 comprises an outlet 302b for allowing material placed into the intake arrangement 302 to move out of the material intake arrangement 302 and towards at least some of the material separation arrangements, particularly the sorting station 304 and the picking conveyor 306 which passes therethrough. The intake arrangement 302 is generally horizontal in use and is mounted on the support chassis 350. Alternatively the intake arrangement 302 may be inclined in use. The material intake arrangement 302 comprises a feed conveyor 302c which is adapted to transport material in the material intake arrangement 302 towards the outlet arrangement 302b i.e. towards the exit of the material intake arrangement 302 The mobile material sorting apparatus 301 comprises an inclined exit conveyor 309 which is adapted to carry material in the material stream from the terminal portion 306c of the picking conveyor 306 past the magnetic separation arrangement 305 and towards the air separation arrangement 303. The air separation arrangement 303 is located towards the distal end 309a of the inclined exit conveyor 309. The air separation arrangement 303 comprises a fan or blower which directs lighter material towards a chute 303a. A lights skip 321 is located at the end of the chute 303a so that lights separated from the waste stream by the air separation arrangement 303 can fall into and be collected in the skip 321.

The magnetic separation arrangement 305 comprises a frame which is attached to the support chassis 350. As shown in FIG. 9, a ferrous metal skip 322 is located on the ground adjacent to the magnetic separation arrangement 305 so that ferrous metal waste separated from the waste stream by the magnetic separation arrangement 305 can fall into and be collected in the skip.

FIG. 10 shows a plan view of the third embodiment of the mobile sorting apparatus and a plurality of storage arrangements 310. In the embodiment of FIGS. 9 and 10, the mobile material sorting apparatus 301 comprises four sorted material transfer arrangements 307, each comprising a chute 307a. Each chute 307a passes through a side wall of the sorting station housing and provides an aperture through which items are able to pass out of the housing. Storage arrangements 310 in the form of skips are placed under the exits of the chutes 307a to collect material which has been separated out from the material stream and placed into the chute 307a by an operative. The direction of sorted material as it passes out of the sorting station 304 via the sorted material transfer arrangements 307 is substantially perpendicular to the direction of the unsorted material stream through the mobile material sorting apparatus 301, although other angles may be used. The layout and design of the mobile material sorting apparatus 301 ensures its compactness compared to prior art arrangements.

FIG. 11 shows a further mobile sorting apparatus 401 according to the invention. The mobile material sorting apparatus 401 of this fourth embodiment comprises: a material intake arrangement 402; a plurality of material separation arrangements 404-405; an unsorted material transfer arrangement 406; a plurality of sorted material transfer arrangements 407; and a transportation arrangement 408. In the embodiment shown in FIG. 11 the plurality of material separation arrangements comprise a sorting station 404 and a magnetic separation arrangement 405.

The mobile material sorting apparatus 401 of the fourth embodiment is again of a generally similar construction to the earlier embodiments with like numerals (e.g. 8,408) denoting similar components. The operation of the mobile material sorting apparatus 401 is similar to that of the earlier embodiments. The distinguishing features of the fourth embodiment 401 are: the form of the material intake arrangement 402; the sorted material transfer arrangements 407; and the picking conveyor having an inclined portion 406a. Other differences include the location and form of the entry arrangements (not shown) and the design of the support chassis 450.

The horizontal material intake arrangement 402 is generally similar to that of the third embodiment shown in FIG. 9. The unsorted material transfer arrangement 406, comprising inclined portion 406a, is generally similar to that of the second embodiment shown in FIGS. 5-8. The sorted material transfer arrangements 407 are generally similar to those of the second and third embodiments. The magnetic separation arrangement 405 of the fourth embodiment is similar to that of the third embodiment shown in FIG. 9.

FIG. 12 shows a further mobile sorting apparatus 501 according to the invention. The mobile material sorting apparatus 501 of this fifth embodiment comprises: a material intake arrangement 502; a plurality of material separation arrangements 504-505; an unsorted material transfer arrangement 506; a plurality of sorted material transfer arrangements 507; and a transportation arrangement 508. In the embodiment shown in FIG. 12 the plurality of material separation arrangements comprise a sorting station 504 and a magnetic separation arrangement 505.

The mobile material sorting apparatus 501 of the fifth embodiment is again of a generally similar construction to the earlier embodiments with like numerals (e.g. 8,508) denoting similar components. The operation of the mobile material sorting apparatus 501 is similar to that of the earlier embodiments. The distinguishing features of the fifth embodiment 501 are: the form of the material intake arrangement 502; the sorted material transfer arrangements 507; and the picking conveyor having an inclined portion 506a. Other differences include the location and form of the entry arrangements (not shown) and the design of the support chassis 550.

The inclined material intake arrangement 502 is a separate feed conveyor. The unsorted material transfer arrangement 506, comprising inclined portion 506a, is generally similar to that of the second embodiment shown in FIGS. 5-8. The sorted material transfer arrangements 507 are generally similar to those of the second, third and fourth embodiments. The magnetic separation arrangement 505 of the fifth embodiment is generally similar to that of the third and fourth embodiments.

FIGS. 13-28 show a sixth embodiment of a mobile sorting apparatus 601 according to the invention. The sixth embodiment of the mobile sorting apparatus 601 is a tracked optical sorter, that is, an optical sorting arrangement mounted on tracks or in some embodiments, wheels.

The mobile material sorting apparatus 601 of the sixth embodiment comprises: a material intake arrangement 602; a material separation arrangement 603; an unsorted material transfer arrangement 606; a plurality of sorted material transfer arrangements 607,617; and a transportation arrangement 608. In the embodiment shown in FIGS. 13-28 the material separation arrangement 603 comprises an optical sorting arrangement 603 which is at least partially located within a sorting station 604. As will be appreciated, one or more further material separation arrangements such as an air separator, trommel or a magnetic separation arrangement may be incorporated into the mobile material sorting apparatus 601, as required.

The material intake arrangement 602 is generally similar to that of the previous embodiments and comprises an entrance 602a for receiving material, for example waste material from e.g. a building or domestic site, or any other material to be sorted, and an outlet 602b for allowing material placed into the intake arrangement 602 to move out of the material intake arrangement 602 and towards the unsorted material transfer arrangement 606. Material can be placed into the intake arrangement 602 via the entrance 602a using e.g. an excavator. The material intake arrangement 602 comprises an inclined feed conveyor 602c adapted to transport material in the material intake arrangement 602 towards the outlet 602b. As can be seen in FIGS. 27 and 28 the outlet 602b i.e. the end portion of the intake arrangement 602 is located within the sorting station 604.

The sorting station 604 comprises a housing 640 having a roof 641 (partially cut away in FIGS. 21-28), two side walls 642, two end walls 643 and a floor 644. In the example embodiment of FIGS. 13-28, the optical sorting arrangement 603 is at least partially located within the housing 640. Operatives such as maintenance operatives can enter the housing 640 through personnel access doors (not shown) located in end walls of the housing 640 to carry out maintenance or other tasks. The personnel access doors may be accessible from the ground via a ladder (not shown) or a set of stairs or other suitable means.

The mobile material sorting apparatus 601 comprises an unsorted material transfer arrangement 606. The unsorted material transfer arrangement 606 is a conveyor 606 which is located within the sorting station 604. The conveyor 606 comprises an input portion 606a, a central portion 606b and a terminal portion 606c. Material which exits the intake arrangement 602 falls onto the input portion 606a. Material is carried through the sorting station 604 on the central portion 606b towards the terminal portion 606c. The conveyor 606 comprises a frame which is attached to the housing 640 and/or the support chassis 650. The conveyor 606 comprises a frame and an endless belt which rotates to carry material thereon. As will be appreciated, the unsorted material transfer arrangement 606 can be made up of a plurality of consecutive conveyor belts and may carry material in either direction through the apparatus 601.

The sorting station 604 comprises a material entrance 604a through which material can enter the sorting station 604 from the intake arrangement 602. The material entrance 604a is located in an end wall 643 of the housing 640. As will be explained in further detail below, the sorting station 604 comprises a material exit 604b through which unsorted/unpicked material in the material stream can exit the sorting station 604 via the optical sorting arrangement 603. The material exit 604b is located on an opposing side of the housing 640 to the material entrance 604a. The unsorted material transfer arrangement 606 is located at least partially within the housing 640 and is adapted to carry material through the sorting station from towards the material entrance 604a towards the material exit 604b.

The mobile material sorting apparatus 601 comprises an optical sorting arrangement 603 adapted to allow the separation of items from the material stream. By “optical sorting arrangement” it is meant an arrangement for sorting material in the material stream which uses electromagnetic radiation such as light, near-infrared radiation and/or infrared radiation to identify items to be separated. It is envisaged that the apparatus 601 can comprise one or more further manual, robotic, optical, near-infrared and/or air sorting arrangements. For example, one or more robotic arms or operatives located within the housing 640 may also be used to manually pick out certain items from the material stream as the stream is carried along the conveyor 606.

The optical sorting arrangement 603 comprises an air supply arrangement 603a, a sensing arrangement 603b in the form of a scanner and a pneumatic separation arrangement 603c. The apparatus 601 also comprises a processor such as a control computer (not shown) for receiving and processing data e.g. from the scanner 603b and for sending commands to the pneumatic separation arrangement 603c. The optical sorting arrangement 603 is partially located within the sorting station housing 640. In particular, the air supply arrangement 603a and the sensing arrangement 603b are located within the housing 640 above the conveyor 606 on a frame 645. The pneumatic separation arrangement 603c is partially located within the housing 640 and is located above at least a portion of each respective sorted material transfer arrangement 607,617.

Incorporation of the optical sorting arrangement 603 into a tracked sorting system 601 carries a number of technical challenges that must be overcome in order for the system to operate effectively. For example, the electronics and scanning devices/sensors located in the scanner 603b are sensitive to movement and vibrations. Even mild vibrations could lead to the machine having to be re-calibrated and could cause damage to some of the components. The present system overcomes this problem by mounting the scanner 603b and/or sensitive components on the frame 645 and/or housing via anti-vibration mounts. Anti-vibration mounts reduce the amplitude of vibrations transmitted to the sensitive components during movement or operation. Furthermore, during movement/tracking of the apparatus 601 mechanical lock-out devices are used to retain components and thereby reduce excess movement. To prevent the sensitive electronic components in the scanner 603b from being damaged by especially high and/or low temperatures, the scanner 603b is fitted with an air conditioning unit to control the air temperature around these components. The scanner 603b where the components are located is further protected from high and low temperatures as it is situated inside an insulated cabin style enclosure. High humidity levels can cause corrosion of some electronic components. To prevent the sensitive electronic components in the scanner 603b from being damaged by humidity the components are protected by the air conditioning system and/or protective coating to stop moisture getting to the components. Smart packaging of the components of the apparatus 601 is required along with bespoke technical solutions to get all items fitted and still ensure access for service and maintenance.

The air supply arrangement 603a is a source of compressed gas, such as a gas cylinder and/or compressor. The compressed gas can be used to create jets of air which are able to move/deflect items in the material stream as they fall off the terminal position of the unsorted material transfer arrangement 606. The cylinder is operable to store compressed gas such as air and output said gas in bursts and/or a steady stream. The compressor is operable to compress air to replenish the compressed air supply in the cylinder.

The sensing arrangement 603b is a scanner for mapping the types (i.e. categories) and locations of items in the material stream.

The pneumatic separation arrangement 603c comprises a housing into which material can pass from the conveyor 606. The pneumatic separation arrangement 603c comprises an air ejection arrangement (not shown). The air ejection arrangement comprises a plurality of apertures or nozzles through which compressed air can be ejected towards items in the material stream. The air ejection arrangement is arranged such that as items pass over the terminal position (not shown) of the conveyor 606 they will pass over the air ejection arrangement, particularly the apertures or nozzles. The apertures or nozzles are arranged across the entire width of the end of the conveyor 606. The air ejection arrangement is located at the terminal position of the conveyor 606 and can be used to eject bursts or jets of air towards items in the material stream as said items pass over the terminal position of the conveyor 606. The bursts or jets of air that are ejected from the apertures or nozzles can be used to cause said items to follow a predetermined trajectory towards the second sorted material transfer arrangement 617, instead of falling under the force of gravity towards the first sorted material transfer arrangement 607. The pneumatic separation arrangement 603c comprises a housing having an outlet for allowing material which enters the pneumatic separation arrangement 603c to move out of the pneumatic separation arrangement 603c and the first or second material transfer arrangements 607,617

In use, items in the material stream pass from the intake arrangement 602 to the unsorted material transfer arrangement 606. When on the unsorted material transfer arrangement 606, items in the material stream are carried towards and pass under the scanner 603b. Data from the sensor is sent to a processor which uses the sensor data (i.e. the time-resolved spectra of the reflected light) to determine the types of material located on the conveyor 606, and their positions on the conveyor 606. In this way, the processor determines the type and location of items in the material stream that are present on the conveyor 606 underneath the scanner 603b shortly before said items are carried into the pneumatic separation arrangement 603c.

The items on the conveyor 606 enter the housing of the pneumatic separation arrangement 603c shortly before reaching the terminal position of the conveyor 606 and the air ejection arrangement.

If the processor determines that an item that is about to pass over the air ejection arrangement should not be separated from the material stream then the item is permitted to simply pass over the end of the conveyor 606 where it will fall under the force of gravity towards the first sorted material transfer arrangement 607. In this case, the item simply passes over the air ejection arrangement and no air is ejected or released through the apertures/nozzles.

If the processor determines that the item passing over the air ejection arrangement should be separated from the material stream then, as the item passes over the nozzle assembly, a burst or jet of air is ejected from the nozzle(s) located directly below the item. This burst or jet of air pushes or blows the item towards the second sorted material transfer arrangement 617. In this way, the burst or jet of air will prevent the item from falling onto the first sorted material transfer arrangement 607 and will deflect the item towards the second sorted material transfer arrangement 617.

The material separation arrangement 603 is adapted for allowing at least one predetermined category of materials to be separated from the material stream. For example, the optical sorting arrangement 603 may be arranged to separate wooden items from the material stream, using bursts or jets of air as described above to deflect wooden items towards the second sorted material transfer arrangement 617 while allowing non-wooden items to fall under the force of gravity onto the first sorted material transfer arrangement 607. Alternatively or additionally the apparatus may be configured to separate other items from the material stream, such as items made of plastic e.g. of a particular type.

Each sorted material transfer arrangements 607,617 is adapted to transfer item(s) to an appropriate location outside the sorting station 604 to a place where said sorted item(s) may be stored, for example with other items in the same material category. While the present embodiment relates to a sorting apparatus 601 having two sorted material transfer arrangements and being used to isolate a single category of material from other material in the material stream, alternative embodiments of the optical sorter include further transfer arrangements which can be used to separate further categories of items from the material stream.

The first sorted material transfer arrangement 607 comprises a first stockpile conveyor 672 at least partially locatable below part of the optical sorting arrangement 603. The first stockpile conveyor 672 is adapted to transfer items to a respective storage arrangement such as a stockpile, skip, cage, bay or silo. The first stockpile conveyor 672 comprises an intake portion 672a located directly below an end of the conveyor 606, and a transfer portion made up of central portion 672b and terminal portion 672c. The intake portion 672a is located below the pneumatic separation arrangement 603c. In the illustrated embodiment of FIGS. 13-28 the intake portion 672a is substantially flat and parallel to the floor of the housing 640, and in use the transfer portion 672b,672c is inclined (see e.g. FIG. 20). While in this embodiment the intake portion 672a is substantially horizontal in use, in further contemplated embodiments the intake portion 672a may be inclined in use.

The first stockpile conveyor 672 is foldable and/or telescopic for transport purposes. The first stockpile conveyor 672 comprises an endless belt which rotates to carry material thereon. In the disclosed embodiments the first stockpile conveyor 672 carries material in a direction which is substantially perpendicular to the direction along which material is carried along the conveyor 606. In alternative embodiments the first stockpile conveyor 672 may be disposed at a different angle compared to the conveyor 606. The first stockpile conveyor 672 is movable between a transport position and a deployment position. The first stockpile conveyor 672 is preferably in the transport position during transport and is moved to the deployment position when it is ready to be used and during use. Movement may be effected manually or using an actuator such as a hydraulic ram.

In the transport position (see e.g. FIGS. 13, 15, 17 and 19) the first stockpile conveyor 672 is folded and/or retracted such that the distal end of the first stockpile conveyor is located adjacent to the mobile material sorting apparatus 601, particularly the housing 640. FIG. 19 shows the first stockpile conveyor 672 in the transport position in which the central portion 672b is folded with respect to the intake portion 672a such that the central portion 672b is adjacent to a sidewall 642 of the housing 640, and the terminal portion 672c is folded with respect to the central portion 672b such that the terminal portion 672c is adjacent to the roof 641 of the housing 640. This ensures that the apparatus 601 is compact during transport.

In the deployment position (see e.g. FIGS. 14, 16, 18 and 20) the transfer portion (formed of the central portion 672b and the terminal portion 672c) extends away from the mobile material sorting apparatus 601 at an angle. FIG. 20 shows the first stockpile conveyor 672 in the deployment position in which the central portion 672b is angled with respect to the intake portion 672a and the terminal portion 672c is parallel to the central portion 672b. The distal end of the first stockpile conveyor 672 (i.e. the distal end of the terminal portion 672c) can extend over e.g. the wall of a storage bay such that items carried on the first stockpile conveyor 672 can pass over the distal end thereof and fall into the storage bay, forming and/or adding to a stockpile therein.

In the embodiment of FIGS. 13-28, the second sorted material transfer arrangement 617 comprises a second stockpile conveyor 682 at least partially locatable below the optical sorting arrangement 603, in particular partially below the pneumatic separation arrangement 603c. The second stockpile conveyor 682 is adapted to transfer items which have been separated from the remaining material stream by the pneumatic separation arrangement 603c to a respective storage arrangement such as a stockpile, skip, cage, bay or silo.

The second stockpile conveyor 682 comprises an intake portion 682a partially located below the housing/outlet of the pneumatic separation arrangement 603c, and a folding portion 682b. In the illustrated embodiment of FIGS. 13-28 the intake portion 682a is inclined with respect to e.g. the conveyor 606 although in further contemplated embodiments the intake portion 682a may be horizontal in use.

The second stockpile conveyor 682 is foldable and/or telescopic for transport purposes. The second stockpile conveyor 682 comprises a frame and an endless belt which rotates to carry material thereon. In the disclosed embodiments the second stockpile conveyor 682 carries material in a direction which is substantially parallel to the direction along which material is carried along the conveyor 606. In alternative embodiments the second stockpile conveyor 682 may be disposed at a different angle compared to the conveyor 606. The second stockpile conveyor 682 is movable between a transport position and a deployment position.

The folding portion 682b of the second stockpile conveyor 682 is pivotably attached to the intake portion 682a thereof. FIG. 27 shows the second stockpile conveyor 682 in the transport position. In the transport position the second stockpile conveyor 682 hangs vertically from the distal end of the intake portion 682a such that there is an angle between the intake portion 682a and the folding portion 682b. FIG. 28 shows the second stockpile conveyor 682 in the deployment position. In the deployment position the folding portion 682b is locked in position such that it is parallel to the intake portion 682a. In this position the distal end of the second stockpile conveyor 682 (i.e. the distal end of the folding portion 682b) can extend over e.g. the wall of a storage bay such that items carried on the second stockpile conveyor 682 can pass over the distal end thereof and fall into the storage bay, forming and/or adding to a stockpile therein. The second stockpile conveyor 682 is preferably in the transport position during transport and is moved to the deployment position when it is ready to be used and during use. Movement between the positions can be done manually or using an actuator such as a ram. The apparatus 601 has a shorter length when the folding portion is in the transport position compared to the deployment position.

As will be appreciated, stockpiles can be created at any suitable position on a site. A stockpile can be created underneath the distal end of the first and/or second stockpile conveyor 672,682. Alternatively or additionally one or more further conveyors may be located underneath the distal end of the first and/or second stockpile conveyor 672,682, in order to carry material towards a stockpile and/or another processing apparatus such as a shredder or separation arrangement.

The mobile material sorting apparatus 601 comprises a transportation arrangement 608. The transportation arrangement 608 allows the mobile material sorting apparatus 601 to move around a site. The transportation arrangement 608 comprises two track assemblies 608a, 608b. Each track assembly 608a,608b comprises a plurality of wheels and an endless track disposed around the wheels. The endless track engages the ground to provide traction and is moved by the wheels to provide motion. Each track assembly 608a,608b is used to propel the mobile material sorting apparatus 601. Each track assembly 608a,608b is attached to an elongate chassis 650 on which the sorting station 604 is mounted. The mobile material sorting apparatus 601 can comprise a native power arrangement (not shown), such as a diesel engine, or can be powered by an external power arrangement. Such power arrangements can be used for powering the components such as the components of the optical sorting arrangement 603, the transportation arrangement 608 and the conveyors 602c,606.

The operation of the mobile material sorting apparatus 601 is as follows. The mobile material sorting apparatus 601 is transported to a site. As will be appreciated, the mobile material sorting apparatus 601 may be transported to a site using a truck or lorry trailer. Alternatively, the mobile material sorting apparatus 601 may move to the site under its own motive force using the transportation arrangement 608. Upon reaching the site, the mobile material sorting apparatus 601 can move around the site under its own motive power using the transportation arrangement 608.

The mobile material sorting apparatus 601 is located proximally to one or more storage arrangements at the site. In contemplated examples the storage arrangements can be formed of a plurality of walls which form partially enclosed silos/storage bays, or can be stockpiles, skips, containers and/or bins. Once the mobile material sorting apparatus 601 is located in an appropriate position adjacent to the storage arrangements, the sorted material transfer arrangements 607,617 are deployed (i.e. moved from the transport positions to the deployment positions) and aligned with the storage arrangements.

Once the mobile material sorting apparatus 601 is suitably located and deployed with respect to the on-site storage arrangements, material is input into the intake arrangement 602. Conveyors 602c,606 are activated to cause the material stream to pass into the housing 640 and towards the optical sorting arrangement 603 where the material stream is sorted in the manner described above.

In use, the material stream travels from the intake arrangement 602 towards the pneumatic separation arrangement 603c where it is separated. Upstream directions are towards the intake arrangement 602 and downstream directions are towards the terminal position of the folding portion 682b.

The direction of the material stream through the mobile material sorting apparatus 601, particularly the unsorted material carried on the conveyor 606, is substantially parallel to the major axis of the material sorting apparatus 601. In the disclosed embodiment, this is substantially parallel to the longest dimension of the material sorting apparatus 601 and the longest dimension of the housing of the sorting station 604. The direction of sorted material as it passes out of the sorting station 604 via the first sorted material transfer arrangement 607 is substantially perpendicular to the direction of the unsorted material stream through the mobile material sorting apparatus 601. The direction of sorted material as it passes out of the sorting station 604 via the second sorted material transfer arrangement 617 is substantially parallel to the direction of the unsorted material stream through the mobile material sorting apparatus 601. The layout and design of the mobile material sorting apparatus 601 ensures its compactness compared to prior art arrangements.

As will be understood by the skilled person, the example embodiments presented above can be modified in a number of ways without departing from the scope of the invention. For example, the mobile material sorting arrangement 1,201,301,401,501,601 may include a screening means such as a screen or trommel. The tracks used in the transportation arrangements 8,208,308,408,508,608 may be replaced by wheels. Any or all of the horizontal conveyors or conveyor portions disclosed herein may alternatively be inclined in use, and similarly any or all of the inclined conveyors or conveyor portions disclosed herein may alternatively be horizontal in use.

In the preceding discussion of the invention, unless stated to the contrary, the disclosure of alternative values for the upper or lower limit of the permitted range of a parameter, coupled with an indication that one of the values is more highly preferred than the other, is to be construed as an implied statement that each intermediate value of the parameter, lying between the more preferred and the less preferred of the alternatives, is itself preferred to the less preferred value and also to each value lying between the less preferred value and the intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof as defined in the appended claims.

1. A mobile material sorting apparatus comprising: a material intake means; a material separation means; at least one sorted material transfer means; and a transportation means, wherein the material separation means comprises an optical sorting means.

2. A mobile material sorting apparatus as claimed in claim 1 wherein the material separation means comprises an optical sorting means directly or indirectly connected to the transportation means.

3. A mobile material sorting apparatus as claimed in claim 1 or claim 2 wherein the optical sorting means comprises a sensing means.

4. A mobile material sorting apparatus as claimed in claim 3 wherein the sensing means is an optical, near infrared or infrared sensor.

5. A mobile material sorting apparatus as claimed in any one of the preceding claims, wherein the optical sorting means comprises pneumatic separation means.

6. A mobile material sorting apparatus as claimed in claim 5 wherein the pneumatic separation means comprises air ejection means.

7. A mobile material sorting apparatus as claimed in claim 6 wherein in use one or more items pass over the air ejection means.

8. A mobile material sorting apparatus as claimed in any one of the preceding claims, wherein the optical sorting means comprises a processing means.

9. A mobile material sorting apparatus as claimed in claim 8 when dependent on claim 3 wherein the processing means is adapted to receive data from the sensing means.

10. A mobile material sorting apparatus as claimed in claim 8 when dependent on claim 5, wherein the processing means is adapted to send data such as commands to the pneumatic separation means.

11. A mobile material sorting apparatus as claimed in claim 8, wherein the processing means is configured to identify the category of one or more objects in the material stream.

12. A mobile material sorting apparatus as claimed in any one of the preceding claims, wherein the or each sorted material transfer means comprises a conveyor means.

13. A mobile material sorting apparatus as claimed in claim 12, wherein the or each sorted material transfer means comprises a lateral conveyor means.

14. A mobile material sorting apparatus as claimed in claim 12 or claim 13, wherein the conveyor means is at least partially locatable below the material separation means.

15. A mobile material sorting apparatus as claimed in any one of claims 12 to claim 14, wherein the conveyor means is at least partially locatable below a sorting station.

16. A mobile material sorting apparatus as claimed in any one of claims 12 to claim 15, wherein the conveyor means is at least partially locatable below a picking bin and/or chute.

17. A mobile material sorting apparatus as claimed in any one of claims 12 to claim 16, wherein the conveyor means is at least partially locatable above the transportation means.

18. A mobile material sorting apparatus as claimed in any one of claims 12 to claim 17, wherein the conveyor means is at least partially locatable between the sorting station and the transportation means.

19. A mobile material sorting apparatus as claimed in any one of claims 12 to claim 18, wherein the conveyor means is at least partially locatable between the floor of the sorting station and the transportation means.

20. A mobile material sorting apparatus as claimed in any one of claims 12 to claim 19, wherein at least one sorted material transfer means is at least partially locatable below the optical sorting means.

21. A mobile material sorting apparatus as claimed in any one of the preceding claims, wherein the or each sorted material transfer means comprises a stockpile conveyor.

22. A mobile material sorting apparatus as claimed in any preceding claim wherein the transportation means comprises two track assemblies, the or each track assembly comprises a plurality of wheels and an endless track disposed around the wheels.

23. A mobile material sorting apparatus as claimed in any preceding claim wherein the mobile material sorting apparatus comprises a support chassis, such as an elongate support chassis.

24. A mobile material sorting apparatus as claimed in claim 23, wherein the transportation means is attachable to the support chassis.

25. A mobile material sorting apparatus as claimed in any preceding claim wherein the material separation means comprises an air separation means.

26. A mobile material sorting apparatus as claimed in claim 25 wherein the air separation means is adapted to generate a flow of air towards material in the material stream.

27. A mobile material sorting apparatus as claimed in any preceding claim wherein the sorting station comprises a manual picking station.

28. A mobile material sorting apparatus as claimed in any preceding claim wherein the material intake means comprises a feed conveyor.

29. A mobile material sorting apparatus as claimed in any preceding claim wherein the mobile material sorting apparatus comprises an unsorted material transfer means.

30. A mobile material sorting apparatus as claimed in claim 29 wherein the unsorted material transfer means comprises a conveyor means.

31. A mobile material sorting apparatus as claimed in claim 29 or claim 30 wherein the unsorted material transfer means passes through the sorting station.

32. A mobile material sorting apparatus as claimed in any preceding claim wherein the material separation means comprises a magnetic separation means.

33. A mobile material sorting apparatus as claimed in claim 32 wherein the magnetic separation means is used to separate ferrous/magnetic material from other material in the material stream.

34. A mobile material sorting apparatus as claimed in any preceding claim wherein the mobile material sorting apparatus comprises a screening means such as a screen or trommel.

35. A mobile material sorting apparatus as claimed in any preceding claim wherein the mobile material sorting apparatus comprises anti vibration mounting means for mounting the optical sorting means.

36. A mobile material sorting apparatus as claimed in any preceding claim wherein the mobile material sorting apparatus comprises mechanical lock out means for reducing excess movement of the optical sorting means during movement/tracking of the apparatus.

37. A mobile material sorting apparatus as claimed in any preceding claim wherein the mobile material sorting apparatus comprises means for preventing moisture engaging with electronic components of the optical sorting means.
